(19) United States
(12) Patent Application Publication
(10) Pub. No.: US 2007/0282739 A1
(43) Pub. Date: Dec. 6, 2007

(54) Computer implemented method and system for rapid verification and administration of fund transfers and a computer program for performing said method

(76) Inventor: Jacob Thomsen, London (GB)

Correspondence Address: BIRCH STEWART KOLASCH & BIRCH, PO BOX 747, FALLS CHURCH, VA, 22040-0747, US

(21) Appl. No.: 11/442,094

(22) Filed: May 30, 2006

(51) Int. Cl. G06Q 40/00

(52) U.S. Cl. 705/39

(57) ABSTRACT

The invention concerns a computer implemented method and system, and corresponding computer-readable medium storing instructions for performing said method, for rapid verification of an account-to-account transfer comprising at least a first transfer between a payer bank account and a first transfer bank account, said method comprising the steps of: receiving payment data from a website; enabling selection of a bank company using a payer's device for identification of a first transfer bank account at the selected bank company, whereto a transfer of funds from a payer bank account is to be made; surveying said identified first transfer bank account and determining when said find transfer has taken place thereto from said payer bank account; and transmitting a transfer verification message to a payee device confirming said fund transfer to said identified first transfer bank account. In an exemplary embodiment, said method further comprising administration of said account-to-account fund transfer further comprising a second transfer from a second transfer bank account to a payee bank account in order to provide a computer implemented payment solution method, said administration comprising the following steps: providing data concerning said payee bank account to which at least part of the fund is to be transferred; transferring a second amount from said second transfer bank account based on said payment data to said payee bank account while providing said payee with said payment data; and settling the differences between said identified first transfer bank account and said second transfer bank account periodically based on predetermined settlement criteria.

### BACKGROUND OF THE INVENTION

1. Field of the Invention

The present invention relates to a computer implemented method and system, and a computer readable medium storing instructions for performing said method, for rapid verification of an account-to-account fund transfer, in particular an international fund transfer, intended for a payee, which may enable administration of said account-to-account transfer in connection with a payment performed by a payer on a website in order to provide for a payment solution method.

2. Description of Related Art

The technical field relates to the field of verifying and administrating payments by a fund sender, e.g. a payer such as a buyer, to a fund receiver, e.g. a payee such as a vendor, using existing physical bank accounts, in particular between bank accounts in different countries or states. This is conventionally administratively complex, costly in fees and slow in transfer time.

Due to differing bank requirements in different countries, it is presently administratively complex to set up and use bank accounts for fund transfers therebetween, in particular between bank accounts in different countries, which is also due to the use of different currencies, and even between bank accounts in different bank companies in the same country, e.g. due to different registration standards or diverging computer systems used. Large costs may be incurred by a payee, which costs partly are due to the time and effort spent for administration, when enabling and performing international fund transfers to the payee bank account, and which partly are due to the bank fees to be paid by him, and thus implicitly the payer, to both sender and receiver bank during a transfer between bank companies, and in particular between banks companies in two different countries.

Further, existing complex settling practices within each bank company and between banks internationally require at least three whole banking days for transferring funds between bank accounts in different countries, and thereby for verifying the transfer. Such bank account transfers directly between payer and payee bank accounts in different countries or states may require the establishment of an individual and identifiable payee bank account. Examples of these are the standardization for identification of bank accounts used for European cross-border payments to help minimise errors and delays by providing IBAN account number for the payee in conjunction with a SWIFT/BIC number identifying the bank; and the standardization in the United States using ABA routing numbers for identifying the bank and the payee bank account in question.

The above problem is in particular evident for network based online payments, e.g. performed on the Internet and in particular when performing international trade and commerce. Many customers now view Internet commerce as being more easily performed than in the physical world and it is increasingly gaining more popularity, as an increased number of products and services become available for sale on the Internet. In this case, the payee may be situated physically in one country and the customer may be situated in another, requiring an international transfer of funds from the payer to the payee.

The problem is even more pronounced in the case when a payee is delivering a network provided service, such as updating programs or Internet sites, or installing new software, or performing real time monitoring of a website for fraud over the network, which service the payer expects or demands to be delivered quickly, i.e. within minutes, hours or at least within a day. Accordingly, the payee is not content to wait several days for verification of the fund transfer, where the service has to be delivered within a short time by the payee, and where the payee has no possibility of verifying the consummation of sale, i.e. the assurance, that the payment has been performed.

This is the reason why merchant websites do not generally offer a payment solution involving account-to-account transfers between physical bank accounts in connection with Internet sales.

Generally, in online sales presently available a payer such as a customer enters a vendors or merchant's website in order to purchase goods and/or services. During said sale, the customer generally provides information concerning him/herself and mode of payment, which at present generally comprise three types of payment solutions.

Firstly, a credit card payment solution is used, wherein the customer enters the credit card number in order to pay for the products/services being offered on said website. The merchant submits the charge to the credit card company and deletes the transaction with the customer once the credit card company authorizes the charge, in a straight-through type processing.

However, many online customers are reluctant to submit their credit card details online and even by phone because they perceive the security to be low when relaying these sensitive personal details on a public network and to persons not known to the customers and situated in other jurisdictions, often geographically far away. Further, many customers perceive the risk of having fraudsters pick up credit card numbers online when being typed in by a process called “phishing” as being high, which may reduce their incentive to perform said typing. Another drawback for a merchant is that chargebacks occur, where the payment is not accepted by the credit card company, e.g. due to errors or fraud, in which case the merchant must cover the expenses for the non-completed transaction, and may risk having already shipped or performed the product or service respectively, before this charge back is registered by him.

Secondly, many larger bank companies now offer a payment solution over the Internet in direct relation to the payee or merchant website. This type of payment solution is called different names, depending on which bank company is offering it, but will in the following commonly be termed an e-payment. The bank company or alternatively one of the merchants subscribing to the e-payment service hosts a website, in which one or more merchants are presenting their offers of commerce. A customer enters this website or e-market, and selects the products for sale, e.g. in an e-shopping cart. When he is content with the number and types of products, he has selected, he accepts to begin e-payment by selecting the bank company in question, which is hosting or is in communication with the website, possibly also entering his postal address for delivery. This initiates an e-bank application, i.e. a virtual bank service providing at least the payer with the ability to transfer money from his own account, which bank service is provided by a website access e.g. through a secure HTTPS connection in a separate window, where the payer may enter by providing a unique password. Then the details of the sale are provided automatically by the e-market to the e-bank application for easy and fast consummation of the payment and ultimate transfer of the amount of money being paid to the payee bank account. A confirmation of the sale is then provided to the customer, e.g. in the e-market window or by e-mail.

However, a disadvantage of this system is that both the payer and the payee must be or must become customers of the same bank company, i.e. the one which provides the e-payment service. This limits the merchant's number of potential customers, in particular they are limited to inland customers and further limits the customer's selection of merchants in the e-market.

Similar considerations are applicable to e-credit card solutions, such as the e-Dankort solution provided in Denmark, even though the payer here is presented with a wider selection of banks associated with the Dankort-card to be utilized. However, the market is limited to inland customers and merchants, respectively.

Thirdly, other approaches to online payment solutions have been conceived, e.g. using virtual or real online bank accounts, or using pre-paid virtual or real cards e.g. electronic wallets or digital tokens for payment. However, all these approaches suffer from a common security problem in that the payer must disclose some form of confidential information, e.g. a PIN code or personal identification, to these systems, either during establishment of the account or wallet or after, even though this information may not be subsequently transmitted over the Internet. Thus, from a security standpoint, these payment solutions are problematic.

Accordingly, the issues that now confront online purchasing systems are the possibility of fraud, lack of security, low execution speed and high resulting transaction costs, both due to the incurring of bank fees and administration time, and the limitations in the market of potential customers and merchant alike.

### SUMMARY OF THE INVENTION

A computer implemented method for rapid verification of an account-to-account transfer comprising at least a first transfer between a payer bank account and a first transfer bank account, said method comprising the steps of: receiving payment data from a website; enabling selection of a bank company using a payer's device for identification of a first transfer bank account at the selected bank company, whereto a transfer of funds from a payer bank account is to be made; surveying said identified first transfer bank account and determining when said fund transfer has taken place thereto from said payer bank account; and transmitting a transfer verification message to a payee device confirming said fund transfer to said identified first transfer bank account.

It may further comprise administration of said account-to-account find transfer further comprising a second transfer from a second transfer bank account to a payee bank account in order to provide a computer implemented payment solution method, said administration comprising the following steps: providing data concerning said payee bank account to which at least part of the fund is to be transferred; transferring a second amount from said second transfer bank account based on said payment data to said payee bank account while providing said payee with said payment data; and settling the differences between said identified first transfer bank account and said second transfer bank account periodically based on predetermined settlement criteria.

Further, there is provided a computer-implemented system and a computer-readable medium storing instructions, executable by a processor, for performing said method.

### DESCRIPTION OF THE DRAWINGS

The accompanying drawings, which are incorporated in and constitute a part of this specification, illustrate embodiments of the invention and, together with the description, explain the principles of the invention. In the drawings:

FIG. 1 is a flow chart of an account-to-account fund transfer verification method according to principles consistent with some embodiments of the invention illustrated by payer actions on a merchant's website being served by said method;

FIG. 2 is an overview of an account-to-account find transfer verification system according to principles consistent with some embodiments of the invention, further comprising an administration application for administering a subsequent account-to-account transfer between a second transfer bank account to a payee bank account which provides for a payment solution; and

FIG. 3 is a view of a detail of the system of FIG. 2 consistent with the principles of the present invention, the view showing a two-step fund transfer between a payer bank account and a payee bank account.

### DETAILED DESCRIPTION

On this background it is one feature of the present invention to provide a method and a system, and a computer-readable medium storing instructions for performing the method, for reducing the time period from when a payment has been requested by a payer until verification of a fund transfer has reached the payee, in particular in relation to payment of a product or service being sold on the Internet, and in particular but not exclusively when the payment is performed between different bank companies and/or internationally between two different countries or states.

Another feature is to reduce the inconveniences and costs experienced by both payers and in particular payees when performing account-to-account fund transfers between physical bank accounts, in particular between countries.

A further feature is to increase the security for both the payer and the payee in such a way, that the former is not requested to submit any sensitive personal information and the latter is provided with an assurance, that the payment has in fact been performed.

Generally, according to the present invention, there is provided a method and a system for rapid verification of an account-to-account fund transfer within a two-step process between physical bank accounts in relation to a payment on a website. The rapid verification method provides for verification of an account-to-account transfer between a payer bank account and a first transfer bank account in a first transfer. In one embodiment thereof, there is further provided a method and a system for administration of said fund transfer and a further second transfer, which enables a payment solution for website payments by providing administration of a subsequent account-to-account transfer between a second transfer bank account and a payee bank account in a second transfer. The accrued differences between said first and second transfer bank account are settled at any given suitable time, which generally is later than the time of both said first and second transfer.

According to the present invention, there is provided a computer implemented method and system, and a computer-readable medium storing instructions for performing said method, for rapid verification of an account-to-account fund transfer from a payer bank account intended for a payee in connection with a payment performed by a payer on a website, said method comprising the steps of: receiving payment data from a website; enabling selection of a bank company using a payer's device for identification of a first transfer bank account at the selected bank company, whereto a transfer of funds from a payer bank account is to be made; surveying said identified first transfer bank account and determining when said fund transfer has taken place thereto from said payer bank account; and transmitting a transfer verification message to a payee device confirming said fund transfer to said identified first transfer bank account.

By surveying an identified first transfer bank account it is possible to determine when said account-to-account fund transfer has taken place and transmit a verification message within a very short time, or verification time period. By the invention it has been realized, that when using one or more transfer bank accounts, e.g. held by a trusted third party, a verification may be transmitted very quickly, if the transfer bank account in question is being surveyed automatically, e.g. by using a third party e-bank application. In the case when the payment is related to a website, the identification of the first transfer bank account made on said website is enabling the surveying of the correct first transfer bank account among one or more. When using an e-bank application for each first transfer bank application

If said transfer to the first transfer bank account is performed by other means than a payer e-bank application, such as a telephone call or personal attendance at the payer bank, this time period results in a prolonged verification time period, at least until the next bank day, which would not be expedient to speeding up the Internet sale procedure by providing a short verification time period. Instead, transfers may be performed using a payer e-bank application, which are performed substantially instantly when transferring between accounts in the same bank company in the same country. Accordingly, said verification time period may be further reduced, where tests performed by applicant has shown verification time periods of between one tenth of a minute and 10 minutes.

A short verification time period is, in particular, necessary and sufficient for e-commerce payments e.g. for services, which the customers legitimately expect are to be provided by the merchant within a short time in real time, e.g. software updates performed over the Internet and the like. How to perform a subsequent transfer of money to a payee bank account is less relevant for the invention, because in fact all the necessary information concerning the payment and the check of an actual transfer has been supplied during the verification method according to the invention. The subsequent transfer may be performed in a conventional way, e.g. by transferring money directly to the payee bank account from said first transfer bank account. However, the account-to-account transfer may be administered and finalized according to an exemplary embodiment of the method according to the invention, which will be described further below.

Given the fact that a bank company is selected by the payer, which bank company holds both the payer bank account and said first transfer bank account, the time period for transferring an amount to said first transfer bank account, when using the payer's e-bank application is reduced to substantially instantaneously. Further, the costs associated therewith are reduced, because many banks provide the service of charging low or even no fees for transferring between accounts within the same bank company.

Said third party is trusted by the payer, because the payer may be confident that when he transfers an amount to the first transfer bank account the sale is going to be consummated subsequently, i.e. that the trusted third party or the transfer service provider is eventually going to transfer the amount due to the payee. Further, said third party is trusted by the payee, in that the payee leaves all or part of the responsibility of administering the account-to-account transfer to said party, while expecting that the amount due is going to be transferred to the payee bank account at some time after the verification.

Bank authentication of the payer is provided automatically when a payer is using his own payer e-bank application, which may be accessed from a limited and identified number of personal computers, for transferring the amount to the first transfer bank account. By the use of the payer's existing e-bank applications the banks pre-authenticate the payers, enforces security and speeds the execution of online transactions. This provides a certain degree of confidence from the third party in that he has in fact received the amount specified, i.e. it reduces the risks for the third party acting as a middleman.

Correspondingly, the security for both the payer and the payee has increased in such a way, that the former is not requested to submit any sensitive personal information, e.g. by using his own payer e-bank application and the latter is provided with an assurance by said third party that the payment has in fact been performed and the amount due will arrive.

Further, when utilizing a trusted third party or middleman holding transfer bank accounts, whereto the payer has transferred the amount due, the payment is not subject to chargeback conditions, as is the case with credit card payments, i.e. it constitutes an irreversible payment. Thus, the third party and ultimately the payee has availed themselves a further increased financial security, when the money is physically present on a physical bank account.

The step of receiving payment data and of enabling selection of a bank company may take place 1) at the same moment in time, or subsequently, either 2) providing selection first and then receiving payment data or 3) receiving payment data and then providing selection. All have their advantages depending on number of payments to be performed, number of bank companies which may be selected, the amount and type of payment data to be received, on payee preferences and the like. For example, if only one bank company is available for selection in the country in question, it may be an advantage to enable the selection first, and then receive the payment data, based on the selection thereof. Another example is to receive the payment data in advance, without knowing which bank company is to be surveyed, for a subsequent early identification of the payment to come, e.g. by the receiving payee.

In further exemplary embodiments of said method and system, said identified first transfer bank account and said payer bank account are provided in the same bank company, and/or in the same country. Often bank companies charge a reduced fee when transferring funds between bank accounts within the company itself, and further when transferring funds between bank accounts within the same country. This reduces the costs associated with the account-to-account transfer being performed.

In a further exemplary embodiment of said method and system, said identified first transfer bank account is selected from a plurality of first transfer bank accounts. By providing more than one first transfer bank account, it increases the probability that a payer holds a payer bank account in one of the bank companies, in which said first transfer bank accounts are established within. This increases the number of available potential payers or customers of the merchant, and thus increases the market potential.

In a further exemplary embodiment of said method and system, each first transfer bank account from the plurality thereof is provided in different bank companies of each country. This further increases the number of potential customers and thus market potential as providing a collection of transfer bank accounts, one for each different bank company in each country, increases the probability that a payer in any country holds a payer bank account in one of these different bank company in the country in question. Optionally, there is established one first transfer bank account for each major bank company in each country being served by said transfer service, which increases the number of potential payers or customers to a majority of payers holding payer bank accounts in such country.

In further exemplary embodiments of said method and system, at least one of said plurality of first transfer bank accounts is held by a third party, and/or a transfer service provider, and/or a merchant. By being the owner of one or more first transfer bank accounts the holder may enjoy the benefits of being able to control and further establish e-bank applications for each of these. In that case bank account holder is allowed the added security layer, the direct control and transaction speed provided by each bank company's own e-bank application. A third party may of course also be said transfer service provider and vice versa. When at least one of said first transfer bank accounts are being held by said third party, e.g. a major money wiring company, the advantage is that there will be reduced establishment costs from by the fact that said third party already holds suitable bank accounts in different countries in the world. If one or more first transfer bank accounts are being held by said transfer service provider, the advantage is that the transfer service provider is able to control and benefit from providing said verification method and system according to the present invention, respectively. If one or more first transfer bank accounts are being held by individual merchants, the advantage is, that the Merchant does not need to rely on a further step in a two-step fund transfer, because he holds the account into which the first step transfer is performed, i.e. the first transfer bank account is the same as the payee bank account. Thus the administration and verification may be performed by the merchant in question, e.g. by checking this account by a payee e-bank application. This reduces the costs necessary for the merchant in question, and is especially suitable in cases, when the payee bank account e.g. by coincidence is situated in the same bank company and country as the payer bank account.

In a further exemplary embodiment of said method, surveying said identified first transfer bank account is started when said bank company is selected on said website. Thus, the surveying time period may be limited, which reduces the processing power needed, increases the efficiency of said method and system and speeds up the process. Accordingly, one first transfer bank may be activated for surveying per customer on the website, which reduces the data transfer capacity necessary for the computer or server, which is performing said method. Alternatively, the surveying is performed continuously. However, the latter requires an increased processing power for surveying an increased number of first transfer bank accounts at the same time, which is of low practicability. Other alternative initiating factors may be the receiving of the payment data, which may be an advantage e.g. if there is only one bank company for selection.

In a further exemplary embodiment of said method, surveying said identified first transfer bank account ends when said transfer verification message is transmitted. Then said first transfer bank account is available for further activity e.g. for subsequent verification for other payer's transfers, and/or subsequent administration, see below, e.g. for transferring amounts of money, e.g. to other transfer bank accounts for settling, or to a payee bank account. The starting and stopping of the individual surveying of each first transfer bank account is limited in time and thus the processing time reduced, see above.

In another exemplary embodiment of said method, surveying said identified first transfer bank account is performed over a predetermined surveying time period. If there has been no verification message transmitted within said predetermined surveying time period, a message may be displayed e.g. to the payer in order to e.g. encourage him to perform the transfer, or to inform him of the stage reached in the process, and/or to said payee in order to inform him of the non-matching transfer. Further, such predetermined surveying time period may be entirely independent from the transmittal of said transfer verification message, and be provided e.g. in order to adapt to expected long transmission data rates. This may be an advantage where the third party is not the same entity as said transfer service provider, or when the surveying time period is be increased due to decreased transmission data rate, or in other cases, where delays are expected in the latter.

In another exemplary embodiment of said method and system, enabling selection of a bank company is performed on said website. The advantage is that the payer using his payer device does not need to leave the Merchant's website in question, which provides the payer's with an increased service. The method according to the present invention may be performed by running an applet upon said Merchant's website. Alternatively, a separate website dedicated to enable the selection of a bank company may be provided, or there may be provided a different way to enable selection, such as a web application enabling automatic selection, e.g. when only one bank company is available for selection, e.g. by clicking on an account-to-account transfer service icon.

In another exemplary embodiment of said method and system, at least the step of surveying comprises at least opening a third party e-bank application for said identified first transfer bank account. This allows for very fast determination of when a fund transfer has taken place into said identified first transfer bank account. This is accomplished by utilizing said e-bank application when surveying the identified first transfer bank account, where the e-bank application is provided by the bank company in which the identified first transfer bank account resides. Tests performed by applicant has shown that determination time periods may be as low as a few tens of a second, where the determination time period starts from the point in time where the payer has submitted his fund transfer request utilizing his payer e-bank application and ends at the point in time when it is determined that a transfer has taken place into the identified first transfer bank account. Thus, the time period for confirming a transfer by surveying the first transfer bank account is further decreased, when using an e-bank application for the first transfer bank account in question. The e-bank applications for all the first transfer bank accounts held may be controlled and run automatically when needed by said method and system according to the present invention. The term “third party e-bank application” is meant as not being limited to the third party held accounts, but may also cover the transfer service provider and/or merchant held accounts, which accounts are being used as first transfer bank account within the principles of the present invention, and the term is only illustrative for an e-bank application being issued by the bank company in question in which the third party or the other parties hold said first transfer bank accounts.

In a further exemplary embodiment of said method and system, said third party e-bank application is utilized to provide data concerning changes within said identified first transfer bank account. Said data concerning changes within said identified first transfer bank account may comprise said payment data, but may also comprise data concerning settlement amounts, see below, and other data, such as accrued interests, etc.

Said data concerning changes may comprise payer entered payment data. Said determination of when said fund transfer has taken place may be made when said received payment data and said payer entered payment data matches. Said payment data may comprise at least an amount and a unique sales identification number. This allows for a check of whether the change changes within said identified first transfer bank account is a fund transfer related to an specific payment on the website. Such check reduces the number of entry errors during payer payment and allows for further processing of said payment data. Thus, errors will be detected, which will reduce the number of fund transfers, which are not identifiable. Accordingly, the payment may be uniquely identified also when verifying it to the payee, which reduces the administration time and costs for the payee, and eases comparison with data e.g. a separate or integrated invoice system of the merchant's. Said payment data may comprise further data, e.g. the currency being used, and/or time stamp of transfer, and/or payer bank account number for use during said account-to-account transfer. The data may be provided from and by the payer or the merchant's website, which reduces the risk of errors being made during said transfer and subsequently during shipment of the product/service to the payer.

In another exemplary embodiment of said method, the fund transfer to said identified first transfer bank account is performed on a payer's device using a payer e-bank application. Thus, the transfer time therebetween is reduced significantly, i.e. it decreases the time period from the point in time when a payer has initiated the fund transfer from his payer bank account to the point in time when the bank company, and e.g. said third party e-bank application, has registered said fund transfer. This is due to the fact that payer bank account and identified first transfer bank account are both provided in the same bank company, and the same bank company has issued the payer e-bank application being used. This significantly reduces the transfer time period from the payer has requested the transfer until the transfer has been performed, i.e. is registered by the third party e-bank application. Test performed by the applicant has resulted in measuring very low transfer time periods, such as between approximately one second to ten minutes, depending on type of e-bank application used, bank company used, and the transmission data rates used in said system, in particular by the payer device being used.

In another exemplary embodiment of said method and system, said verification message to the payee comprises a time stamp indicating the time of arrival of said fund transfer to said identified first transfer bank account. This provides the payee with further information as to the correct arrival of the payment for the service or product being sold, and also enables the payee to give an overview of the status of the two-step process.

In another exemplary embodiment of said method said verification message to the payee is transmitted to a web server providing said website. This provides for the payee to use the verification message automatically within the web server, e.g. for displaying a verification message to the payer, and/or closing down the transfer application by closing the window in which it is showing.

In another exemplary embodiment of said method said verification message to the payee is transmitted to a payee accounting system. This provides for the payee to use the verification message automatically within such payee accounting system, e.g. for automatic shipping instructions or the like.

In another exemplary embodiment of said method and system, it further comprises transmitting information to a payer's device that said fund transfer has been verified. Accordingly, the payer is provided with the information, that the transfer i.e. the payment has been completed for his part. He may then use this information, e.g. in order to close down his e-bank application.

In an exemplary embodiment, said transmitting information to said payer's device is performed by a display of said information on said website. Thus, more information concerning the payment is presented and incorporated within the merchant's website. This increases the information flow to the payer, when he is still on the Merchant's website in question.

In an exemplary embodiment, said transmitting information to the payer's device is performed by transmitting an electronically relayed message, such as an e-mail to said payer's computer or an SMS to said payer's telephone, This increases the information flow to the payer, even if he has chosen to close down his computer before receiving said information.

In one exemplary embodiment of a method and a system according to the invention, it further comprises administration of said account-to-account fund transfer further comprising a second transfer from a second transfer bank account to a payee bank account in order to provide a computer implemented payment solution method, said administration method comprising the following steps: providing data concerning said payee bank account to which at least part of said fund transfer is to be transferred to; transferring a second amount from said second transfer bank account based on said payment data to said payee bank account while providing said payee with said payment data; and settling the differences between said identified first transfer bank account and said second transfer bank account periodically based on predetermined settlement criteria. Said second transfer bank account and said payee bank account may be provided in the same bank company and/or be provided in the same country. Said second transfer bank account may be one of a plurality of second transfer bank accounts. Each second transfer bank account from the plurality thereof may be provided in different bank companies of each country, and at least one of said plurality of second transfer bank accounts may be held by a third party, and/or a transfer service provider, and/or a merchant.

By the invention it has been realized, that a payment solution method has been provided by a two-step method comprising the verification method according to the invention and said further administering step of said find transfer.

Hereby, the total time period from the first transfer, i.e. from payer bank account to first transfer bank account, and to the second subsequent transfer from the second transfer bank account to said payee bank account may be as long as is suitable, which is not necessarily as short as possible, even though this may be convenient for the payee. Instead said total time period may be decided on a case-to-case basis, and may depend on different factors, such as e.g. which bank company offers the lowest transfer fee at which moment in time, bank company rules and standards, and payee accounting requirements.

However, an account-to-account transfer method is provided, which may potentially significantly speed up the resulting total transfer time, because verification and administration of the transfer has been split up and may be provided in common for an automatic sharing of payment data etc. However, the need for speed is here reduced, because the payee is entrusting the trusted third party with the responsibility that the first transfer has in fact taken place. This is particularly suitable for e-commerce payments requiring substantially instant verification of payment to payees.

The trusted third party is thus alleviating the administrative burden for the payee by the fact that the payee is required to supply the transfer service provider with a reduced number of sensitive data, e.g. at least payee bank account number and bank company to be used when performing this subsequent transfer. He does not need to supply an authorization for the transfer service provider to access his bank accounts, nor further personal or sensitive data.

Further, when performing international trade requiring transferring amounts between countries the payee is not required to establish his own specific account for international transfers. Instead, he may use one or more of his own existing local bank accounts for such transfers.

As mentioned above, the criteria for establishing and holding a bank account are different in various countries. In some countries, the legal entity owning the account must be having its place of business or must reside in the country. In other countries, it is sufficient to provide a correspondence address. In any case, it is the identification of the bank account and owner which is important for establishing an account and ultimately for identifying the recipient/sender of a fund transfer (e.g. using IBAN/SWIFT addresses or ABA numbers). As mentioned above, this is administratively complex when transferring funds internationally, however, with the method according to the invention, this administrative burden has been lifted away from the financial institutions, payers and payees and has been moved to the trusted third party, who establishes and maintains all transfer bank accounts.

When using a computer implemented system and method according to an exemplary embodiment of the present invention, comprising a transfer verification and administration, the task of administering the subsequent transfer is performed swiftly, quickly and automatically, which reduces costs and lowers the subsequent time of product delivery from the merchant.

By waiting to settle the differences between first and second transfer bank accounts until an appropriate moment, such as e.g. once a day, a week or a month, the sum of money actually transferred may be reduced. This lowers the total costs of bank transfer fees, in particular when this transfer takes place between different banks and between different countries. The reason why the settlement may be performed following the payments per se is that several payments are performed between countries or bank companies, whereby payments from one or more customers in one bank company may cover the expenses for payments from one or more customers in another bank company.

Further, said third party may have a sufficiently large number of first and second transfer bank accounts available, the total sum of money transferred for settlement between e.g. two different countries, may be kept low, which further decreases the costs, i.e. bank fees for country-to-country transfers between the physical bank accounts.

Further, the amount of total incurred bank fees resulting from the transfers will be significantly reduced as compared to conventional transfers between bank accounts in different banks. This is the fact that 1) the first transfer is performed within the same bank company, 2) the second transfer is also performed within the same bank company, which may be a different bank company than in 1), in which cases both the transfer fees and the transfer time, when using the e-bank application provided by the bank company in question, are very low, often equal to zero. And 3) the settlement between the each of e.g. a plurality of transfer bank accounts may postponed and summed up from the total number of fund transfers performed during a given time period, e.g. one or more bank days, a week or a month, and be settled by transferring one or more settling amounts between a reduced number of different bank companies, i.e. between a reduced number of transfer bank accounts, such as one settling amount between e.g. two transfer bank accounts in two different bank companies in two different countries.

The establishment and administration of and transfers to and from the plurality of first and second transfer bank accounts may be performed by said transfer service provider using said transfer administration application, and the transfer service provider may thus charge the clients of the service provided, e.g. the payee for example a certain percentage of the amount being transferred e.g. during one of said transfers. This is to cover the expenses of these services and provide the transfer service provider and/or third party with a possibility of charging the merchant or payee directly and in relation to the payment in question for the service rendered.

Using predetermined settlement criteria enables lower total costs for the total transfer. Examples of such criteria are using a currency converter in order to enable a buy at e.g. the most profitable exchange rate at day rate, to allow for using a bank company, which provides the lowest fee when transferring between bank accounts in different countries, different tools for hedging, and for selecting the best moment in time for settlement, e.g. based on exchange day rate, time periods when commerce intensity is low, or the like.

In further exemplary embodiments said identified first transfer bank account and said second transfer bank account are provided in different bank companies, and/or in the same or different countries. Accordingly, the possibility for providing an international payment solution method is provided, because the fact that the transfer bank accounts are situated in the same country or different countries, and/or the same or different bank companies is not crucial to the transfer process, i.e. does not affect the total transfer time period nor the administrative process of the method and system according to the invention, and even less so when utilizing e-bank applications, both by payer and by said system.

In yet another exemplary embodiment said plurality of first transfer bank accounts are the same as said plurality of second transfer bank accounts. This enables a settlement using cost reducing settlement criterias, and also reduces establishment costs, while at the same time provides the basis for an efficient and timely administration of each transfer being performed within said method.

In yet another exemplary embodiment said data concerning said payee bank account is provided as a database of a plurality of payee bank accounts, where the payee bank account to transfer funds to is identified using said payment data. This is an advantage, when there is more than one payee to be serviced by e.g. the transfer service provider for a reliable and quick retrieval of the payee to which the payment relates.

In another exemplary embodiment said data concerning said payee bank account is provided together with said payment data. This may be an advantage if a payee is new to the system in which case this is one way for a merchant to establish himself as a payee. This is also an advantage, when the transfer service provider is not the same entity as the third party, in which case the third party is not the intended recipient of the payment data

In a further exemplary embodiment said data concerning said payee bank account is provided only once. This may be for example when the method is performed for the first time. This is an advantage when there is always only one recipient, e.g. a selected payee representing a group of payees, or during test operations, e.g. where the service provider or third party is acting as payee.

The payee bank account number or numbers are stored by the system and method according to the invention, and reused for each transfer to the payee in question. This reduces administration for the payee and the trusted third party. Alternatively, the payee bank account number to be used for the transfer may change according to which sale the payment is for, and/or the customer's country of delivery, or payee bank account country. In such a case, the system according to the invention may be in communication with the customers separate invoice system for the provision of the relevant payee bank account to be used.

In a further exemplary embodiment, said first amount may be less than, equal to or more than said second amount according to payment scheme used, such as said second amount being equal to said first amount plus transfer service provider fee. Payment schemes may include special discounts, e.g. during certain time periods or for certain customers of the transfer service, both payer and payee, or on large orders. Said amounts, i.e. first amount (entered by payer), transfer amount (necessary for a verified amount) and second amount (transferred by system to payee), may be the same or different from each other in order to allow for increased benefits, i.e. better income, to payee and to service provider and/or third party.

In a further exemplary embodiment, settling comprises transferring a settling amount between at least one of said plurality of first and second transfer bank accounts and at least another one of said plurality of first and second transfer bank accounts. In a further exemplary embodiment, said transferring a settling amount is performed using said third party e-bank application. Accordingly, the settling is performed between physical bank accounts, i.e. between two or more accounts of said plurality of first and second transfer bank accounts, and by the same system for administering said account-to-account transfer. This reduces error frequency and automates the process.

In a further aspect of the invention there is provided a computer-readable medium storing instructions, executable by a processor, for performing a method for rapid verification of an account-to-account transfer comprising at least a first transfer between a payer bank account and a first transfer bank account, said method comprising the steps of: receiving payment data from a website; enabling selection of a bank company using a payer's device for identification of a first transfer bank account at the selected bank company, whereto a transfer of funds from a payer bank account is to be made; surveying said identified first transfer bank account and determining when said fund transfer has taken place thereto from said payer bank account; and transmitting a transfer verification message to a payee device confirming said fund transfer to said identified first transfer bank account.

Said transfer service provider may provide the computer power for running the main part of the computer program for at least the transfer verification application, optionally also for the administration application, which transfer service provider program surveys the first transfer bank account and verifies the transfer to the payee. Another part of the program is provided to the merchant for application onto his website, e.g. in the form of an application program interface (API), which when implemented on the website transmits the relevant information to the computer program running on the transfer service provider server, which may be a web server.

The method and system according to the invention is applicable and operable within the existing bank system framework, i.e. there is no need to adapt or to conform to any standards nor to develop any new ones. Thus, a quick and reliable international transfer of funds is enabled.

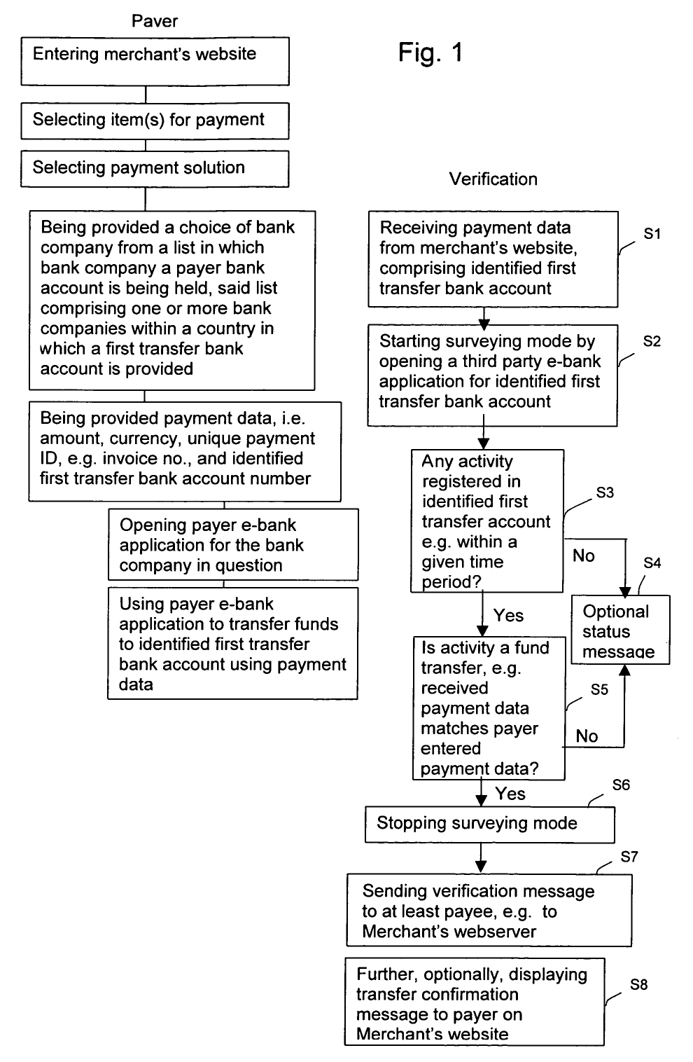

FIG. 1 is a flow chart of an account-to-account fund transfer verification method according to principles consistent with some embodiments of the invention illustrated by payer actions on a merchant's website being served by said method.

A payer is entering a merchant's website, he then selects the items, he wishes to pay for, and then he selects the payment solution, which he would like to use for payment. When selecting the payment solution method or account-to-account transfer method according to the invention, the following is provided by said method:
In step S1 it is receiving payment data from said merchant's website, comprising the number of said identified first transfer bank account and the amount to be transferred. The transmittal of said payment data is provided by said website, e.g. in the form of a website bug or HTML programming within the site, and is based upon the selection by said payer of a bank company, in which the payer holds a payer bank account, to which the payer is availed the possibility of using a payer e-bank application to control and transfer said amount. The bank company or companies available for selection are the bank company or companies, in which a third party is holding first transfer bank accounts in the payers country.
In step S2, a surveying mode is started by the system opening a third party e-bank application for said identified first transfer bank account. Meanwhile or at the same time the payer is being provided the number of said identified first transfer bank account and payment data, e.g. amount, currency, unique payment identification number, e.g. invoice number. Then, the payer is on the website being asked to perform the transfer using said information by using his payer e-bank application for the bank company in question, which he then is able to perform.
In step S3, it is checked whether any change or activity is registered in the identified first transfer account e.g. within a given time period. If that is the case, go to step S5. If not, got to step S4.
In step S4, an status message may optionally be transmitted, e.g. to the payer by a display on said merchant's website in order for the payer to start or restart the find transfer, and/or to the payee in order to inform him of the status of the process.
In step S5, it is checked whether the change or activity is a fund transfer, e.g. whether the received payment data matches the payer entered payment data. If not, go to step S4.
In Step S6, the surveying mode is stopped, e.g. the third party e-bank application for the identified first transfer bank account is closed down or alternatively left active, but not surveyed.
In Step S7, a verification message is transmitted to at least payee, e.g. to Merchant's web server as an output of said verification method.
Optionally, in step S8, a transfer confirmation message is displayed to payer on Merchant's website.

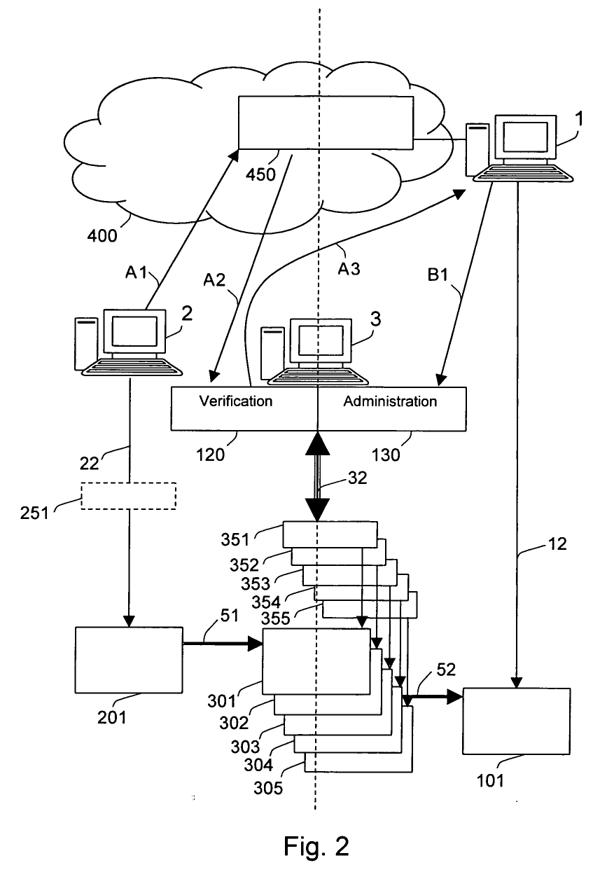

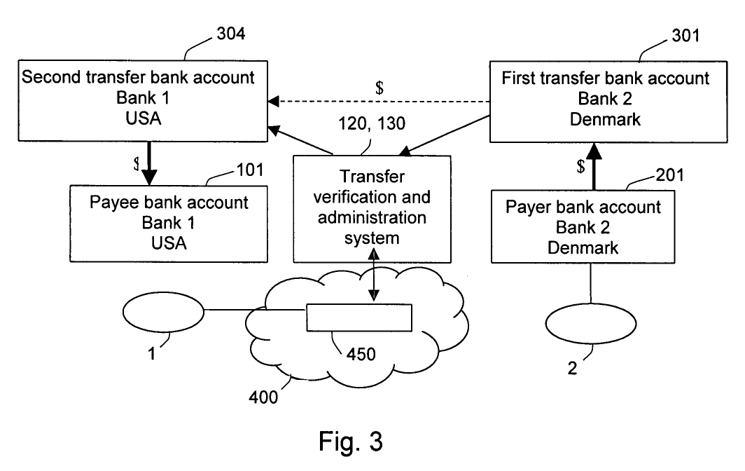

The different steps will be explained further below in relation to FIGS. 2 and 3.

As shown in FIG. 2, a system according to an exemplary embodiment of the invention comprises a combination of two system parts, a verification application 120 and an administration application 130, as indicated by the vertical dotted line, to the left and right hand side of it, respectively. Alternatively, the two system parts may be provided separately as two different systems or applications, which may be in communication in such a way, that the services rendered by each or one part of the system may be used by the other part. Generally, a combination method and system according to the invention allows for account-to-account fund transfers in order to enable a payment solution for paying for products or services provided on the Internet 400.

A merchant or payee operates a payee device 1, e.g. an online vendor physically situated in the United States of America is providing a website 450 on the Internet 400 using a web server 1 in order to sell his product, e.g. books or an Internet provided service such as a software update. The customer or payer operates a payer device 2. The payer, i.e. the person or entity who is to become the buyer of said product and who for example may be an Internet user physically situated in Denmark, is entering A1 said website 450 via his device 2, e.g, such as a computer or mobile telephone, in order to initiate a purchase of said merchant's products. The payer device 2 may be a computer or another interface for example for allowing the payer to operate a conventional web browser by entering in the URL address for the merchant's website 450. In response, the merchant's device 1, such as a computer providing a web server, displays the website 450, which contains web pages on which his products and services are offered for sale. These pages may be supported by various servers and databases of conventional form, and may be in communication with the merchant's accounting computer system (not shown).

A transfer service provider using a device 3 such as a web server or Internet connected computer administers and supports said system as a payment solution for fund transfer verification and administration service to merchants offering said products and services. This transfer service provider may be independent from the merchant and customer, and be associated with or may be an Internet Payment Service Provider (IPSP). Alternatively, the merchant may be the transfer service provider for his own and/or one or more other merchant's websites.

According to the account-to-account transfer method and system, it comprises the utilization of a plurality of first and second transfer bank accounts 301, 302, 303, 304, 305, owned fully or partially by a trusted third party, or/and the transfer service provider, and/or a financial institution such as a credit card company, one or more bank companies, or a international fund transfer company, and/or an IPSP, and/or one or more of said merchants. The plurality of first and second transfer bank accounts are held in as many different countries and different bank companies as is feasible and financially possible in order to supply the merchants and customers with as wide a range of possibilities for doing business within one country or internationally with each other as possible. This will be further explained below.

The underlying concept of the present invention is to provide a plurality of transfer bank accounts, one or more in each country being served, at least one in each major bank companies therein. Each transfer bank account is available at least for being surveyed and further for being controlled by a third party e-bank application provided by said bank company in question. Each third part e-bank application is in turn controlled by said verification and administration application, e.g. when running on a web server, which then is providing the transfer service necessary to verify and administer the account-to-account fund transfer required.

The term e-bank application means a computer implemented application, in general an Internet application, which provides the services of a virtual bank, i.e. where at least surveying of one or more physical bank accounts is possible, and further controlling said accounts.

### Verification Application

In FIG. 2, the first part of the system 120 verifies a payment for the merchant device 1. The payer or customer is using his device 2 to access the website 450 for providing input A1 concerning his selections, e.g. selecting the products he wishes to buy, or selecting mode of payment. The online payment of said product involves a choice of payment options, which is presented on the merchant's website 450. The customer can pay in conventional ways offered by the merchant e.g. by providing credit card details. However, the customer will also be presented with the opportunity to pay using a global account-to-account payment solution according to the present invention, comprising said verification part.

After selecting a payment solution according to the invention, the customer is, see step S1 of FIG. 1 presented with a choice of selection of bank companies, from which list he is to select one bank company in which he, i.e. the payer, holds a payer bank account from which he would like to pay, e.g. using his payer e-bank application. Such selection of bank companies may take different forms, e.g. a pull down list, a presentation of bank companies logos to be clicked on, or the like, which may be provided within the merchant's website, or in relation thereto, or separate therefrom. For example, the customer may in website 450 be selecting from a pull-down list of all the bank companies for each or for all countries, in which first transfer bank accounts have been established at that point in time by said transfer service provider, said third party and/or said merchant himself, e.g. the list may look like this:

Bank 1, USA

Bank 1, Denmark

Bank 2, Denmark

Bank 3, Denmark

Bank 3, Sweden

Bank 4, Germany.

Alternatively, the country of the customer may be identified by the verification application, for example by the website being providing his IP-address, or by similar identification as is known to the skilled person, in which case only a list of bank companies in that identified country is available for selection. Alternatively, the customer or payer may be presented with a possibility of selecting the country from which the payer bank account is situated from a list of countries, in which first transfer bank accounts have been defined or established, prior to selecting the bank company to be used in the selected country.

Assuming he has selected Denmark as the position of his payer bank account, he is on the website then offered a choice between Bank 1, i.e. a major bank in Denmark, Bank 2, a second major bank in Denmark, and Bank 3, a third major bank in Denmark. In order to perform the most rapid verification and to decrease the total cost of the coming transfer, the payer may be informed that he may preferably or only select a bank company in which he has his own payer bank account 201.

Obviously, he may also choose to use an account in a bank company, which is not on the list, but this will seriously increase the resulting verification time period, generally with one day, as the bank settlement procedures between different bank companies require at least one bank day to transfer the money from the payer bank account in one bank company to the transfer bank account in another bank company. This is also the case, if the customer decides not to use or does not have an e-bank application, but instead is relying on e.g. a phone call or personal attendance at the bank for transferring the amount to the first transfer bank account. This may also be due to the fact that the transfer service provider and/or third party and/or merchant has not yet established a transfer bank account in the country of the payer. However, the use of a payer bank account, to which the payer is allowed the use of an e-bank application 251 is one exemplary embodiment, because this reduces delays in verifying the transfer, given the fact that an account-to-account transfer performed by a payer e-bank application between accounts in the same bank company is performed substantially instantaneous, and that this reduces the costs and administration time incurred therewith.

In FIG. 2, the payer has using the payer device 2 selected to use his own bank company, Bank 1 in Denmark, which accordingly harbours not only his own payer bank account, but also a first transfer bank account 301. In FIG. 3 is shown a more detailed view of the total transfer in the two-step process between the two transfer bank accounts, the first transfer bank account 301 and the second transfer bank account 304.

The payer may then be invited to perform a bank account transfer e.g. by opening and using his own e-bank application 251 on his own payer bank account 201 into said identified first transfer bank account 301, where this payer e-bank application may be opened by the payer and appear in a separate window, or may be opened by and appear in relation to the website 450 in question, e.g. in a separate window. Alternatively he may be invited to use a separate bank transfer request provided by the website for said transfer to said identified first transfer bank account 301. In order to increase the customer's reliance on the system, the e-bank application is the one being provided by the bank company in question.

Accordingly, optionally separately from the merchant website, e.g. using the same device 2 and in a new, separate Internet browser window, the payer opens and enters his e-bank application 251, which is issued and run by his bank company, Bank 1 in Denmark in which the payer bank account 201 is residing. He completes the money transfer from his payer bank account 201 to the first transfer bank account 301 using information he is provided with on the website 450 for the purchase in question, i.e. at least the number of the first transfer bank account 301 in Bank 1 in Denmark, the amount of money for covering the payment (possibly including the transfer service provider's fees for providing the service), and a unique payment identification number for identifying the purchase. This information may be entered in the relevant fields in the e-bank application, e.g. number of bank account to transfer to, and information to the recipient, e.g. in a message field provided by said e-bank application, respectively.

Using the payer's own e-bank application provides for added security for the payer, as no personal information is disclosed to any entity besides the payer and his own bank. That is, the transfer of confidential information to the bank company does not pass through a merchant or third party. Further, this provides added security to the transfer service provider and thus payee, because the use of a certified payer e-bank application ensures in a high degree that a transfer of money has in fact been performed.

As shown in FIG. 1, during transfer verification, see also step S2 in FIG. 1, the system is provided with data A2 from the website 450 concerning the payment, comprising at least the amount to be paid, which may be equal to the price of the product or products selected, and a unique payment identification number for identifying the specific purchase, e.g. such as a invoice number, and further data, such as optionally an identification code for identifying the customer or payer device 2 in question. These payment data are provided automatically by the system from the merchant's website 450, e.g. when the customer selects the bank company to be used for transfer.

At a given moment in time, e.g. the same moment as mentioned above, the system 120 is initiating a surveying mode, in which the transfer bank account 301 is activated by the use of the corresponding third party e-bank application 351, which is available for surveying for the transfer service provider device 3, e.g. when the transfer service provider is the trusted third party, who owns the transfer bank accounts 301, 302, . . . , 305, or alternatively, when the transfer service provider device 3 is at least able to survey said transfer bank accounts owned by said trusted third party, e.g. by an issued authorization From said third party. As shown in step S3 in FIG. 1, this mode may be terminated at a given point in time, e.g. when a verification of a successful transfer has been transmitted to the merchant device 1, or when an message has been posted during delays or errors in said fund transfer as also shown in step S4 in FIG. 1. Another alternative is to have each or every available e-bank application active continuously for surveying, but this will require substantial data transmitting and receiving power, which may be detrimental to service speed of the transfer service provider.

Optionally, see step S5 in FIG. 1, said payer entered payment data is checked against the website provided payment data, and if there is a match, the transfer to the first transfer bank account is accepted by the system. If not a match, i.e. one or more parts of said data is not matching, an message may optionally be posted to the payee and/or payer, as also shown in step S4 in FIG. 1, and the transfer is not verified.

As shown in FIG. 2, if the transfer to the first transfer bank account 301 is accepted by the system, and thus no status message due to transfer errors has been generated, the surveying mode may optionally be stopped, as is shown in step S6 in FIG. 1, and a transfer verification message A3 is transmitted by the system 120 to the payee device 1, as shown in step S7 in FIG. 1. Such message A3 may be provided for use by the website 450 or alternatively by the web server providing said website 450. Alternative means of messages are known to the skilled person, and may comprise an e-mail or SMS message e.g. to the merchant's sales department, or the setting of a flag in the website server.

Further payment data may be provided to the payee or to the transfer service provider for use by the second part of the system 130 or by the payee device 1 to identify the sale for which the payment is due, such as a time stamp when mode of payment or payment solution is selected by the customer and/or when the fund transfer to the identified first transfer bank account has been registered, and/or customer ID number, such as IP-address of the customer computer, and/or product ID numbers identifying the individual products selected by the customer for an eased delivery, and the like.

Optionally, as shown in step S8 in FIG. 1, the payer is provided with a confirmation message on his device 2, in any appropriate way known to the skilled person, e.g. an e-mail to the payer's computer, an SMS to the payer's telephone and/or a confirmation message displayed on the merchant's website, that the transfer has been verified to the merchant or payee, for his information

### Administration Application

The second part of the system according to the invention, i.e. the fund transfer administration application enables the administration of said account-to-account transfer from a second transfer bank account 304 held by said trusted third party to a payee bank account 101. The second part of the system or right hand side of FIG. 2 comprises means for providing data concerning the payee bank account 101 to which the payment is to be transferred. As an example, when a merchant has decided to subscribe or be provided with the transfer service, the merchant may log in on a separate website (not shown), held by the transfer service provider device and/or trusted third party. He may then on said separate website be asked to provide details as to which payee bank account 101 he is going to use for the subsequent transfers. Alternatively, the merchant or payee may provide this information using different or the same means, such as an e-mail message, SMS, during signing of a service contract or the like, whereafter the system is provided with the data thus acquired for the payee in question. Accordingly, the merchant only provides this information once during subscription to the service, which reduces administration costs. Alternatively, the website 450 may be provided with an interface to the merchant's invoice system, which often lies in a separate computer system. In that case, the merchant's invoice system is provided with an opportunity to select which of a collection of payee bank accounts, e.g. provided in different countries or bank companies, it would like to have the transfer in question performed to. The merchant's invoice system may select the same country, where the payer is having his account, in order to reduce the total cost to be paid to the transfer service provider 3, who provides the transfer service or payment solution according to the invention.

Here also, the payee bank account 101 is provided by a bank company, Bank 1 in a country, USA in which said trusted third party holds a second transfer bank account 304, see FIG. 2 for the same reasons as described in relation to the first transfer. Again, the trusted third party may alternatively be the transfer service provider and/or one or more merchants.

If the purchase is confirmed by the payee information and the amount checks out based on the payment data provided during verification, the same amount, optionally minus a payee transfer fee for the transfer service provider 3 and/or third party, is transferred by the transfer administration application utilizing the corresponding third party e-bank application 354 from the second transfer bank account 304 situated in the same bank company as the payee bank account 101 to the latter. Said amount may alternatively be the same as the amount due for the payment and any outstanding transfer fee may be paid later, e.g. as a total fixed or calculated fee over a month of transfers. However, the system is able at this stage to deduct the costs for performing said service, e.g. a fixed percentage of the total price of product/service being sold by the merchant, or a fixed amount per payment performed. Different payment schemes may further be used when dealing with specific customers or specific bank companies are being used. These may comprise discounts in provider fees due to large orders, or the like.

Given that it, in said exemplary embodiment of is the same application, i.e. system according to the invention, which is performing the data gathering, the amount check and the transfer to the payee bank account 101, this may be performed securely and above all, very fast.

Said payment data may be the same data as during verification, but may also include further data as mentioned above, such as customer ID, time stamp, and the like, which aids in identifying and performing the sales order for the payee or merchant.

As seen from the above and FIG. 2, in order to settle the difference between first and second transfer bank account 301 and 304, a settlement must be performed, indicated by a dotted arrow between the first and second transfer bank accounts 301, 304. The time period in which to perform it and the selected approach to settlement may in many cases be decided upon by the transfer service provider 3, given certain limitations set by the bank companies, e.g. concerning maximum transfer amounts e.g. per day, and the like.

Accordingly, different predetermined settlement criteria may used for the settlement.

The incurred accumulated differences due to the first and second transfers performed between the first and second transfer bank accounts may be settled periodically at any appropriate given time interval, e.g. once a day, every two days, every week or the like, where a shorter period reduces the economical risk for the transfer service provider 3, and a longer period may be beneficial when considering other factors, such as beneficial exchange rates. Different settlement procedures are available, which are known to the skilled person and any one of these may be used as alternative.

As an example, the predetermined settlement criteria may be chosen such that the total performed transfers between two or more transfer bank accounts is calculated, and only the resulting sum difference is settled between two or more of said accounts.

The predetermined settlement criteria used may comprise a comparison between the different bank transfer fees and also between the different interest rates offered by each bank company, in which there are provided transfer bank accounts 301, 302, . . . , 305. For example, some banks companies charge very low fees and/or high interest rates for large amounts being settled, in which case these banks may be selected for such settlements between transfer bank accounts.

Further, said predetermined settlement criteria may comprise information concerning the available exchange rates provided by the bank companies of each of the transfer bank accounts, in order to provide the most favourable day rate at the time of payment, to minimize any exchange losses and also to provide the most favourable transfer cost when transferring between countries. By using the system according to the invention this enables the fact that the currency exchange rate, which is being used during payment, may even be displayed on the merchant website 450 at the time of sale, which currency exchange rates depends on the payer country and/or bank company selected by the payer for payment. Due to the rapid verification and faster administration of the transfer to the payee bank account 101, this provides the possibility of the customer performing the payment at substantially the daily exchange rate, which may increase payer satisfaction with the transfer service provided on the merchant's website 450.

The settlement criteria may be predetermined automatically and adaptively by said transfer administration application on the basis of the above stated information.

As shown in FIG. 2, the verification and administration of the transfer is made possible through the transfer verification and administration device 120, 130 provided at least partly by the transfer service provider, e.g. by computer program code running on the transfer service provider's application server 3, which may be in communication with the payee device 1's website 450, where the second part of the computer program code is running, e.g. provided as an API application to the merchant website 450.

Alternatively, at least part of said transfer administration application may be provided and/or run either on a server controlled by said trusted third party and/or on the application server for the payee website 450. It may be provided as a stand alone application, either accessible by a network or by a servelet, or may be integrally provided with either the merchant's, the transfer service provider's, or the third party's website server application.

Said transfer administration application is at least able to administer, i.e. control the debiting and crediting, i.e. the settling performed on the plurality of first and second transfer bank accounts 301, 302, . . . , 305. Said system may be established by running said instructions stored on said computer-readable medium according to the invention, which system is then in control of each e-bank application 351, 352, 353, 354, 355, which is available for use by the service provider or third party due to the fact that first and second transfer bank accounts are being held by said third party, whereto e-bank applications are available. Alternatively, the transfer administration application is provided integrated, e.g. provided in cooperation between different bank companies e-bank applications, e.g. as an e-bank transfer application common for all bank companies, which is able to transfer funds, e.g. internationally by a method according to the invention. Another alternative is that the transfer administration application is provided with at least part of the functionalities and authorizations of the individual third party e-bank applications for all first and second transfer bank accounts held. In that case there is no need for the added security, which the use of a bank administered third party e-bank application provides.

As mentioned above, said plurality of transfer bank accounts 301, 302, . . . , 305 is provided and maintained by said transfer service provider or said trusted third party, where said plurality comprises at least a first transfer bank account 301 in the same bank company as said payer bank account 101 and a second transfer bank account 304 in the same bank company as said payee bank account 201, see FIG. 2. The number of transfer bank accounts surveyed and administered by the system is depending on number of payers and payees served by the system, in particular the latter may be the deciding factor as to the number and location of transfer bank account established and controlled by the method and system according to the invention. Said plurality of first transfer bank accounts may be the same ones as said plurality of second transfer bank accounts, because this decreases the resulting costs from bank transfer fees, because the debiting and crediting may be performed on the same account, while being administered and thus controlled by the system according to the invention.

The total number of transfer bank accounts, which can be administered by the administration application 130 according to the invention is in principle limitless. However, different considerations may be taken into account. The total number may be kept to a minimum in order to reduce the administration costs induced by the number of transfer bank accounts to be established. This is not a problem, however, if the owner of the accounts already previously is holding bank accounts, which may be used as transfer bank accounts, e.g. when the trusted third party is e.g. a credit card company or an international money transfer provider. At least one transfer bank account may be established at least within each major bank of each country, at least those bank companies in which payees are holding their payee bank accounts 101. In fact, the number and bank company placement of payee bank accounts 101 owned by the merchants subscribing to the transfer service according to the invention may be the deciding factor as to where and how many transfer bank accounts are being established by the transfer service provider or trusted third party.

Further, the number of payees and payers, respectively subscribing and being logged on to the website 450, and accordingly to the system according to the invention, is limitless. This is a matter of selecting the appropriate server capacity and the programming thereof.

In fact, if an increasing number of payees are subscribing to the system and method according to the invention, the costs of establishing transfer bank accounts may be reduced, because more payees will mean an increased probability, that they are using the same bank company, in which case the same transfer bank account can be used for serving more payees, and a number of transfer therebetween may be combined during settlement, which may reduce the total bank transfer fee incurred.

Given the fact that said second transfer is made between accounts in the same bank company, between second transfer bank account 304 in Bank 1 and payee bank account 101 in the same bank, Bank 1, the bank fees incurred thereby can be kept low. This is one of the concepts forming the basis for the present invention, the fact that transfer fees incurred when transferring between bank accounts in the same bank are generally low or even non-existing, in particular between bank accounts in the same bank company in the same country. Some bank companies charge a relatively low fee when transferring between different countries in the same bank company, others do not.

As a supplement, confirmation of this subsequent transfer, i.e. to the payee bank account, is provided to the payee. The transfer administration application may be in communication with an e-mail server, in which case the confirmation may be by way of an e-mail transmitted to an e-mail server 26, which is accessible by the payee, e.g. using his payee device 1, or by the way of an SMS, e.g. generated automatically by said administration device, e.g. to a mobile phone for the payee sales department. The subsequent transfer confirmation may be provided directly to the website 450 or a separate transfer service provider website, which is in communication with the merchants invoice system, in which case the confirmation information may be stored and used directly by the latter.

The payees subscribing or entering into the fund transfer scheme as described above may allow a direct coupling of certain data from their website application server with said website of the transfer service provider, said data e.g. being payee bank account number, unique payment codes used for each payment, transfer confirmation, and the like, for example in direct communication with the merchant's accounting system. Certain of these payee data may also be provided in other conventional ways, e.g. using e-mails or providing these data by paper.

It has by the invention been realized, that when the computer program is running, it is performing a method and realizing a system according to the invention, which method offers rapid verification and in one embodiment eases the administration for a merchant and provides easy and secure transfer of money for the customer.

It has further been realized, that the use of e-bank applications or the like computer implemented application is relevant for the rapid result of the system and method according to the invention, i.e. for the rapid verification as provided therewith. However, it has also been realized that customers, who have access to and wishes to use the merchant's website in question, in general also will have access to at least establish such e-bank application, if having a bank account. Accordingly, customers and merchants, which hold bank accounts, both in industrialized and developing countries are potential users of the present system and method, which fact enables a very large market potential.

It has further by the invention been realized, that aid fund transfers may also be unrelated to website payments for sales, in stead payments may be conceived broadly and also comprise fund transfers for charity, or for money transfers in general, not related to products/services, but instead to the transfer per se, where payment data is to be conceived as at least comprising a transfer ID and an amount.

We claim:

1. A computer implemented method for rapid verification of an account-to-account transfer comprising at least a first transfer between a payer bank account and a first transfer bank account, said method comprising the steps of:
receiving payment data from a website;
enabling selection of a bank company using a payer's device for identification of a first transfer bank account at the selected bank company, whereto a transfer of funds from a payer bank account is to be made;
surveying said identified first transfer bank account and determining when said fund transfer has taken place thereto from said payer bank account; and
transmitting a transfer verification message to a payee device confirming said fund transfer to said identified first transfer bank account.

2. The method according to claim 1, wherein said identified first transfer bank account and said payer bank account are provided in the same bank company.

3. The method according to claim 1, wherein said identified first transfer bank account and said payer bank account are provided in the same country.

4. The method according to claim 1, wherein said identified first transfer bank account is selected from a plurality of first transfer bank accounts.

5. The method according to claim 4, wherein each first transfer bank account from the plurality thereof is provided in different bank companies of each country.

6. The method according to claim 4, wherein at least one of said plurality of first transfer bank accounts is held by a third party.

7. The method according to claim 4, wherein at least one of said plurality of first transfer bank accounts is held by a transfer service provider.

8. The method according to claim 4, wherein at least one of said plurality of first transfer bank accounts is held by a merchant.

9. The method according to claim 1, wherein surveying said identified first transfer bank account is started when said bank company is selected on said website.

10. The method according to claim 9, wherein surveying said identified first transfer bank account ends when the transfer verification message is transmitted.

11. The method according to claim 1, wherein surveying said identified first transfer bank account is performed over a predetermined surveying time period.

12. The method according to claim 1, wherein enabling selection of a bank company is performed on said website.

13. The method according to claim 1, wherein at least the step of surveying comprises at least opening a third party e-bank application for said identified first transfer bank account.

14. The method according to claim 13, wherein said third party e-bank application is utilized to provide data concerning changes within said identified first transfer bank account.

15. The method according to claim 14, wherein said data concerning changes comprises payer entered payment data.

16. The method according to claim 15, wherein said determination of when said fund transfer has taken place is made when said received payment data and said payer entered payment data matches.

17. The method according to claim 16, wherein said payment data comprises at least an amount and a unique sales identification number, said received payment data comprising a transfer amount and said payer entered payment data comprising a first amount.

18. The method according to claim 1, wherein the fund transfer to said identified first transfer bank account is performed on a payer's device using a payer e-bank application.

19. The method according to claim 1, wherein said verification message to the payee comprises a time stamp indicating the time of arrival of said fund transfer to said identified first transfer bank account.

20. The method according to claim 1, wherein said verification message to the payee is transmitted to a web server providing said website.

21. The method according to claim 1, wherein said verification message to the payee is transmitted to a payee accounting system.

22. The method according to claim 1, further comprising transmitting information to a payer's device that said find transfer has been verified.

23. The method according to claim 22, wherein transmitting information to said payer's device is performed by a display of said information on said website.

24. The method according to claim 22, wherein transmitting information to the payer's device is performed by transmitting an electronically relayed message, such as an e-mail to said payer's computer or an SMS to said payer's telephone.

25. The computer-implemented method according to claim 1,
further comprising administration of said account-to-account fund transfer further comprising a second transfer from a second transfer bank account to a payee bank account in order to provide a computer implemented payment solution method, said administration comprising the following steps:
providing data concerning said payee bank account to which at least part of said fund transfer is to be transferred to;
transferring a second amount from said second transfer bank account based on said payment data to said payee bank account while providing said payee with said payment data; and
settling the differences between said identified first transfer bank account and said second transfer bank account periodically based on predetermined settlement criteria.

26. The method according to claim 25, wherein said second transfer bank account and said payee bank account are provided in the same bank company.

27. The method according to claim 25, wherein said second transfer bank account and said payee bank account are provided in the same country.

28. The method according to claim 25, wherein said second transfer bank account is one of a plurality of second transfer bank accounts.

29. The method according to claim 28, wherein each second transfer bank account from the plurality thereof is provided in different bank companies of each country.

30. The method according to claim 28, wherein at least one of said plurality of second transfer bank accounts is held by a third party.

31. The method according to claim 28, wherein at least one of said plurality of second transfer bank accounts is held by a transfer service provider.

32. The method according to claim 28, wherein at least one of said plurality of second transfer bank accounts is held by a merchant.

33. The method according to claim 25, where said identified first transfer bank account and said second transfer bank account are provided in different countries.

34. The method according to claim 25, where said plurality of first transfer bank accounts are the same as said plurality of second transfer bank accounts.

35. The method according to claim 25, where said data concerning said payee bank account is provided as a database of a plurality of payee bank accounts, where the payee bank account to transfer funds to is identified using said payment data.

36. The method according to claim 25, where said data concerning said payee bank account is provided together with said payment data.

37. The method according to claim 25, where said data concerning said payee bank account is provided only once, such as when the method is performed for the first time.

38. The method according to claim 25, wherein said first amount may be less than, equal to or more than said second amount according to payment scheme used, such as said second amount being equal to said first amount plus transfer service provider fee.

39. The method according to claim 25, wherein settling comprises transferring at least one settling amount between at least one of said plurality of first and second transfer bank accounts and at least another one of said plurality of first and second transfer bank accounts.

40. The method according to claim 39, wherein transferring a settling amount is performed using said third party e-bank application.

41. A computer-implemented system for rapid verification of an account-to-account transfer comprising at least a first transfer between a payer bank account and a first transfer bank account, comprising a verification application comprising:
a receiver module for receiving payment data from a website;
a selector module for enabling selection of a bank company using a payer's device for identification of a first transfer bank account at the selected bank company, whereto a transfer of funds from a payer bank account is to be made;
a surveyor module for surveying said identified first transfer bank account and for determining when said fund transfer has taken place thereto from said payer bank account; and
a transmitter module transmitting a transfer verification message to a payee device confirming said fund transfer to said first transfer bank account.

42. The system according to claim 41, wherein said identified first transfer bank account and said payer bank account are provided in the same bank company.

43. The system according to claim 41, wherein said identified first transfer bank account and said payer bank account are provided in the same country.

44. The system according to claim 41, wherein said identified first transfer bank account is selected from a plurality of first transfer bank accounts.

45. The system according to claim 44, wherein each first transfer bank account from the plurality thereof is provided in different bank companies of each country.

46. The system according to claim 44, wherein at least one of said plurality of first transfer bank accounts is held by a third party.

47. The system according to claim 44, wherein at least one of said plurality of first transfer bank accounts is held by a transfer service provider.

48. The system according to claim 44, wherein at least one of said plurality of first transfer bank accounts is held by a merchant.

49. The system according to claim 41, wherein said surveyor module is operable for opening a third party e-bank application for said identified first transfer bank account.

50. The system according to claim 49, wherein said third party e-bank application is operable for providing data concerning changes within said identified first transfer bank account.

51. The system according to claim 50, wherein said data concerning changes comprises a first amount transferred in said fund transfer and corresponding payer entered payment data.

52. The system according to claim 51, wherein said surveyor module is operable for said determination of when said fund transfer has taken place is made when said received payment data and said payer entered payment data matches.

53. The system according to claim 41, wherein said transmitter module is operable for transmitting information to said payer's device indicating that said fund transfer has been verified.

54. The system according to claim 41, wherein said payment data comprises at least an amount and a unique sales identification number.

55. The system according to claim 41,
further comprising an administration application for administration of an account-to-account fund transfer further comprising a second transfer from a second transfer bank account to a payee bank account in order to provide a computer implemented payment solution, said administration application comprising:
a payee bank identification module for providing data concerning said payee bank account to which at least part of said fund transfer is to be transferred,
a transfer module for transferring a second amount from said second transfer bank account based on said payment data to said payee bank account while providing said payee with said payment data; and
a settling module for periodically settling the differences between said identified first transfer bank account and said second transfer bank account based on predetermined settlement criteria.

56. The system according to claim 55, wherein said second transfer bank account and said payee bank account are provided in the same bank company.

57. The system according to claim 55, wherein said second transfer bank account and said payee bank account are provided in the same country.

58. The system according to claim 52, wherein said second transfer bank account is one of a plurality of second transfer bank accounts.

59. The system according to claim 58, wherein each second transfer bank account from the plurality thereof is provided in different bank companies of each country.

60. The system according to claim 58, wherein at least one of said plurality of second transfer bank accounts is held by a third party.

61. The system according to claim 58, wherein at least one of said plurality of second transfer bank accounts is held by a transfer service provider.

62. The system according to claim 58, wherein at least one of said plurality of second transfer bank accounts is held by a merchant.

63. The system according to claim 58, wherein said identified first transfer bank account and said second transfer bank account are provided in different countries.

64. The system according to claim 58, where said plurality of first transfer bank accounts are the same as said plurality of second transfer bank accounts.

65. The system according to claim 58, which is operable to survey and settle said plurality of first and second transfer bank accounts.

66. The system according to claim 55, wherein said first amount may be less than, equal to or more than said second amount according to payment scheme used.

67. A computer-readable medium storing instructions, executable by a processor, for performing a method for rapid verification of an account-to-account transfer comprising at least a first transfer between a payer bank account and a first transfer bank account, said method comprising the steps of:
receiving payment data from a website;
enabling selection of a bank company using a payer's device for identification of a first transfer bank account at the selected bank company, whereto a transfer of funds from a payer bank account is to be made;
surveying said identified first transfer bank account and determining when said fund transfer has taken place thereto from said payer bank account; and
transmitting a transfer verification message to a payee device confirming said fund transfer to said identified first transfer bank account.

68. The computer-readable medium according to claim 67, further storing instructions wherein at least the step of surveying comprises at least opening a third party e-bank application for said first transfer bank account.

69. The computer-readable medium according to claim 68, further storing instructions wherein said third party e-bank application is utilized to provide data concerning changes within said identified first transfer bank account.

70. The computer-readable medium according to claim 67, further storing instructions wherein said data concerning changes comprises a first amount transferred in said fund transfer and corresponding payer entered payment data.

71. The computer-readable medium according to claim 67, further storing instructions for said determination of when said fund transfer has taken place is made when said received payment data and said payer entered payment data matches.

72. The computer-readable medium according to claim 67, further storing instructions for performing a method for administration of an account-to-account fund transfer further comprising a second transfer from a second transfer bank account to a payee bank account in order to provide a computer implemented payment solution method, said administration method comprising:
providing data concerning said payee bank account to which at least part of the fund is to be transferred;
transferring a second amount from said second transfer bank account based on said payment data to said payee bank account while providing said payee with said payment data; and
settling the differences between said identified first transfer bank account and said second transfer bank account periodically based on predetermined settlement criteria.

73. The computer-readable medium according to claim 72, further storing instructions wherein settling comprises transferring a settling amount between at least one of said plurality of first and second transfer bank accounts and at least another one of said plurality of first and second transfer bank accounts.
